(19) United States
(12) Patent Application Publication
(10) Pub. No.: US 2026/0043280 A1
(43) Pub. Date: Feb. 12, 2026

(54) VEHICLE DOOR WITH ACTUATION DEVICE FOR GENERATING A SWITCH SIGNAL, AND MOTOR VEHICLE

(71) Applicant: AUDI AG, Ingolstadt (DE)

(72) Inventor: Sven STRALKOWSKI, Gaimersheim (DE)

(73) Assignee: AUDI AG, Ingolstadt (DE)

(21) Appl. No.: 18/998,245

(22) PCT Filed: Sep. 12, 2023
(86) PCT No.: PCT/EP2023/074960

§ 371 Date: Jan. 24, 2025

(30) Foreign Application Priority Data
Oct. 12, 2022 (DE) 102022126580.3

(51) Int. Cl. E05B 81/78; E05B 79/08

(52) U.S. Cl. CPC E05B 81/78; E05B 79/08

(57) ABSTRACT

An actuating device for generating a switching signal, for example for a lock on a motor vehicle door, has a first actuation region and a sensor region spaced from the first actuation region. A measuring device in the sensor region undergoes a deformation in a second direction when the first actuation region is subjected to force in a first direction. The measuring device then emits a switching signal of the first type due to the deformation.

### FIELD

The invention relates to a vehicle door with an electrically switchable lock and with an actuating device for generating a switching signal for opening the lock. The invention also relates to a motor vehicle with a corresponding vehicle door.

### BACKGROUND

In motor vehicles, the idea of opening doors purely mechanically has been abandoned. For example, WO 2017/151685 A2 discloses the provision of a sensor that is integrated into a window shaft strip of the door. If force is applied to an actuation region, the sensor detects this and opens or closes the door. It is also known from DE 20 2015 102 898 U1 to provide a door handle with electrical sensors for operator detection in a window shaft strip.

The disadvantage of these actuating devices is that the user has to apply force to a very specific point (e.g. a handle region).

From DE 10 2015 015 073 A1 an actuation device for a motor vehicle is known in which force can be applied to strain gauges as sensors via a rocker, i.e. by lever action. This is intended to be used, among other things, to switch a warning light function or an automatic start-stop system on and off.

In an actuation unit according to DE 10 2014 222 668 A1, a base body is elastically deformed and this deformation is detected by a force sensor arranged in the same base body.

DE 11 2005 003 197 T5 relates to a device for activating a motorized mechanism via a touch-pad for opening or closing a window, sunroof, trunk or side sliding door.

The documents mentioned do not deal with, or what is stated therein contradicts, a desire to make a door handle and the like invisible by installing the sensor system in the window shaft strip of the door.

### SUMMARY

It is therefore an object of the invention to provide an actuating device in a vehicle door which can be designed to be comfortable to operate.

The object is achieved by a vehicle door and a motor vehicle with this vehicle door.

The actuating device used in the vehicle door according to the invention for generating a switching signal for opening the lock has a first actuation region and a sensor region spaced apart from the first actuation region. A measuring device is arranged in the sensor region, a portion or element of which undergoes a deformation in a second direction when the first actuation region is subjected to a force in a first direction. The measuring device then outputs, based on the deformation, a switching signal of a first type. It is further provided that the vehicle door comprises a window and an associated window shaft, and that each actuation region is provided on or as a window shaft strip closing off the window shaft. In this way, a large-area first and/or second actuation region is provided.

The one aspect of the invention according to which the sensor region is spaced from the actuation region enables the provision of completely different sensors, namely, according to the further aspect in the invention, of such a sensor which detects a deformation. Due to the spacing, the actuation region can be designed to have a much larger surface area, since applying force to the first large-area actuation region at a first location can cause a deformation and applying force to the same first large-area actuation region at a second location can equally cause the deformation. Thus, the actuating device can be designed in particular as a large-area element, as can be provided in the window shaft strip of the vehicle door. The first actuation region can extend over several centimeters, and it may then be irrelevant where exactly in the first actuation region the force is applied.

By spacing the sensor region from the first actuation region, it is also possible that the second direction (in which the portion or element of the measuring device deforms) is different from the first direction, namely the direction in which force is applied. Preferably, the second direction can also be opposite to the first direction. Here, “direction” is generally understood to mean an indication that can be provided by using a vector. The points of application of the respective force are naturally located at a distance from one another. If the second direction is opposite to the first direction, in particular a slight tilting movement between the first actuation region and the sensor region can be used. This is possible due to the spacing of the sensor region from the first actuation region.

According to a further preferred embodiment, the actuating device has a second actuation region which is spaced from the first actuation region and from the sensor region. The portion or element of the measuring device (or another portion or element of the measuring device) undergoes a deformation in a fourth direction, which is different from the second direction, when the second actuation region is subjected to force in a third direction. Due to this deformation, the measuring device then emits a switching signal of the second type in the fourth direction.

In this embodiment, two switching signals can be distinguished from one another: the first type of switching signal and the second type of switching signal. The first actuation region can be used to open the door, for example, the second actuation region to close it, or vice versa. In the motor vehicle, it may also be possible to variably define the effect of the first type of switching signal and the effect of the second type of switching signal. It is also not excluded that both switching signals are used alternately to close a door that is already open or to open a door that is already closed, so that the user can then use either the first actuation region or the second actuation region to change the state of the door lock.

According to a preferred embodiment, the first and fourth directions are identical (parallel vectors), and/or the second and third directions are identical (parallel vectors).

This can be achieved in particular by a type of tilting movement during actuation, wherein the tilting takes place in one direction according to the application of force to the first actuation region and in the other direction according to the application of force to the second actuation region. Tilting can occur without joints, especially (microscopically) within a massive body.

To detect the directions of deformation, the measuring device can have a strain gauge. Alternatively or additionally, an inductive sensor and/or a capacitive sensor can be used. In the latter case, an induction or capacitance is provided in an element which is deformed when the respective actuation region is acted upon. For example, with an inductive sensor, an operating oscillating circuit changes its frequency in this way. For example, it is conceivable that when an inductance moves in the second direction due to deformation, the frequency of the oscillating circuit is shifted upwards, and when it moves in the fourth direction opposite to the second direction, the frequency is shifted downwards. In the capacitive sensor (“metal over capacity”, MoC), the capacitance is changed in the sensor surface.

According to a preferred embodiment of the actuating device, it has a base body (in particular made of metal or hard plastic, hard plastic material), of which a handle portion provides the first actuation region and/or the second actuation region and a foot portion provides the sensor region. The handle portion can at the same time have the shape of a head portion. The term “handle portion” implies that its actuation can take place like with a handle. For this purpose, it is preferably provided that the foot region has means for fastening the actuating device to an external object. The external object may in particular be a vehicle door the lock of which is to be operated. In this way, the actuating device is easy to install. The handle portion can then protrude from a window shaft if necessary.

Accordingly, the vehicle door according to the invention has an electrically switchable lock and an actuating device of the type according to the invention for the lock.

The motor vehicle according to the invention comprises the vehicle door according to the invention with the actuating device according to the invention.

The invention can also be described as a method for opening or closing a lock.

For applications or usage situations that can arise in the method and which are not explicitly described here, it can be provided according to the method, that a fault message and/or a request for input of user feedback is output and/or a standard setting and/or a predetermined initial status are set.

The invention also includes the control device for the motor vehicle. The control device can have a data processing device or a processor device which is configured to carry out an embodiment of the method according to the invention. For this purpose, the processor device can have at least one microprocessor and/or at least one microcontroller and/or at least one FPGA (Field Programmable Gate Array) and/or at least one DSP (Digital Signal Processor). Furthermore, the processor device can have program code which is configured to carry out the embodiment of the method according to the invention when it is executed by the processor device. The program code can be stored in a data storage of the processor device. A processor circuit of the processor device can have, for example, at least one circuit board and/or at least one SoC (System on Chip).

The invention also includes developments of the method according to the invention, which have features as already described in the context of the developments of the motor vehicle according to the invention. For this reason, the corresponding developments of the method according to the invention are not described again here.

The motor vehicle according to the invention is preferably designed as an automobile, in particular as a passenger car or truck, or as a passenger bus or motorcycle.

As a further solution, the invention also comprises a computer-readable storage medium, comprising instructions which, when executed by a computer or a computer network, cause it to execute an embodiment of the method according to the invention. The storage medium can be embodied, for example, at least partially as a non-volatile data memory (such as a flash memory and/or as an SSD-solid state drive) and/or at least partially as a volatile data memory (such as a RAM-random access memory). However, the storage medium can also be operated, for example, as a so-called app store server on the Internet. A processor circuit with at least one microprocessor can be provided by the computer or computer network. The commands can be provided as binary code or assembler and/or as source code of a programming language (such as C).

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a side view of the actuating device mounted on a vehicle door according to an embodiment of the invention;

FIG. 2a shows a side view of the motor vehicle according to the invention in detail with the door comprising the actuating device according to the embodiment according to FIG. 1 and

FIG. 2b shows a plan view of the arrangement according to FIG. 2a.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

An actuating device, designated as a whole by 10, according to an embodiment of the type according to the invention comprises a first actuation region 12 and a foot region 14 providing a sensor region. An intermediate region 16 is arranged between the first actuation region 12 and the foot region 14. The foot region 14 carries a flange 18 which is screwed to a vehicle door 100 by means of screws 20.

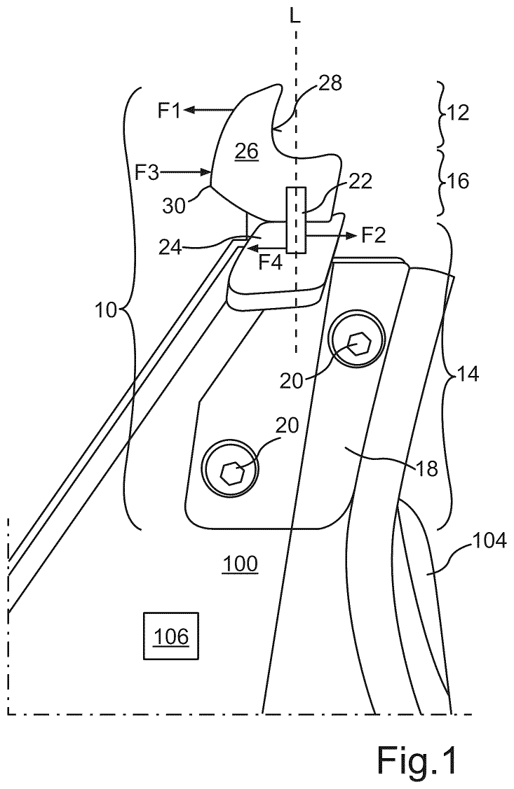

FIG. 1 shows the opened vehicle door 100 in side view. The actuating device 10 is partially recessed between a front plate 102 and a rear plate 104 of the door, in particular in its base region 14. In contrast, the actuation region 12 and the intermediate region 16 protrude. The number of screws is not defined by the exemplary embodiment. Alternatively, the screws can be located behind the outer plate 102, and the screwing is then carried out via a through hole in the plate.

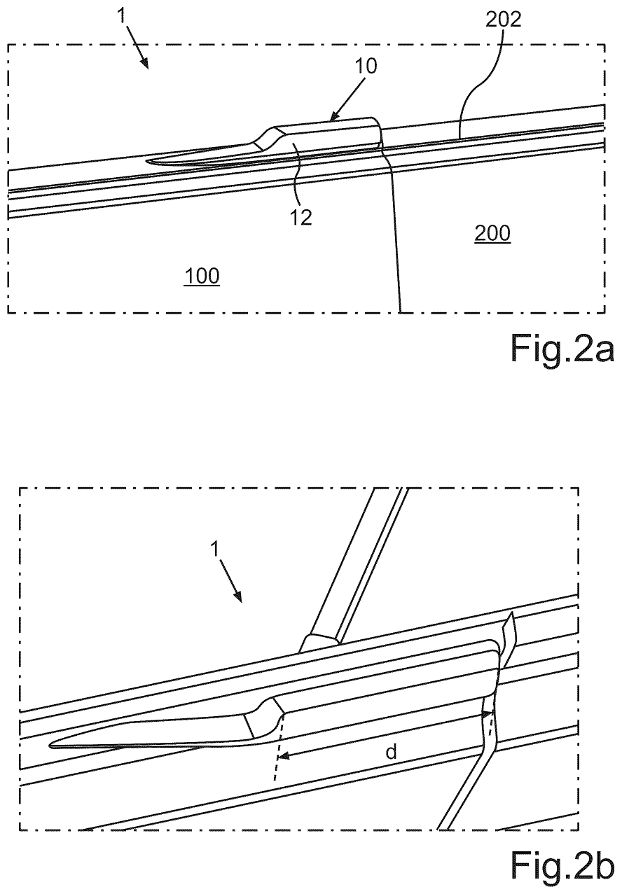

This is also evident from FIG. 2a, which shows a detail of a motor vehicle designated as a whole with 1. The actuating device 10 protrudes with its actuation region 12 upwards, forming a kind of window shaft strip. The actuating device is thus more or less flush with the rest of the window shaft strip, for example on the subsequent door 200 with the window shaft strip 202, whereby the motor vehicle 1 as a whole can be given a smooth and streamlined appearance (“flush”).

Back to FIG. 1: In the foot region 14 as a sensor region, a strain gauge 22 is provided, as well as an evaluation circuit (not shown in the figure) and the like. The strain gauge can be injection-molded with the evaluation electronics as a whole in a body which is formed from the actuation region 12, the intermediate region 16 and a part of the foot region 14. Alternatively, a portion 24 can be provided in the foot region 14, which portion is attached to an upper handle region 26. Preferably, the portion 24 and the handle region 26 are made of hard plastic or (chrome-plated) steel. Such bodies are relatively rigid. If a user now pulls in the first actuation region 12 by allowing his finger to grip the surface 28 behind the grip region 26, the entire body experiences a microscopic deformation (deformation in the range of between 20 and 500 μm). (The user does not perceive this microscopic deformation, but perceives the handle as rigid.) The force F1 of pulling in the first direction causes a force F2 in the opposite direction on the strain gauge. The strain gauge thus emits a signal of the first type, which is converted by the switching electronics and a control unit 106 (for example in the vehicle door) into electrical signals for opening the lock of the vehicle door (not shown here).

This tilting movement is possible because the grip region 26 is L-or C-shaped in cross portion, so that the point of application 28 is located outside above the strain gauge 22. The effect is greater the further outward the surface 28 is located relative to an axial line L of the strain gauge. The C-shape of the grip region 26 provides a second actuation region 30 at the location of a curvature of the grip region 26. Here, the entire body can now be pressed in the opposite direction by means of the force F3, whereby a force F4 is now exerted on the strain gauge 22 in the opposite direction to the force F3 due to a microscopic tilting movement of the C-shape. With an accuracy of ±15°, preferably ±10°, more preferably ±5°, more preferably ±2.5°, even more preferably ±1°, particularly preferably ±0.5°, the fourth direction is equal to the first direction F1. With an accuracy of ±15°, preferably ±10°, more preferably ±5°, more preferably ±2.5°, even more preferably ±1°, particularly preferably ±0.5°, the direction F3 is equal to the direction F2.

Due to the concept of detecting a deformation, preferably only microscopic, in the foot region 14 spaced from the first actuation region 12 and the second actuation region 30, it is less important where exactly the user action takes place. As can be seen from FIGS. 2a and 2b, the actuation regions extend over a distance of d of, for example, between 2 and 20 cm, preferably between 3 and 15 cm. This ensures a high level of actuation comfort while achieving the goal of providing the actuating device inconspicuously.

For alternatives without strain gauges, the sensor (inductive or capacitive, etc.) can be arranged in the same place as shown for the strain gauge. The above statements regarding the forces F1 to F4 then apply analogously.

Overall, the examples show how a multi-functional column door handle can be provided.

1-10. (canceled)

11. A vehicle door, comprising: an electrically switchable lock and an actuating device for generating a switching signal for opening the lock, wherein the actuating device has a first actuation region and a sensor region spaced from the first actuation region, wherein a measuring device is arranged in the sensor region, a portion or element of which measuring device undergoes a deformation in a second direction when the first actuation region is subjected to force in a first direction, and the measuring device emits a switching signal of the first type due to the deformation, wherein the vehicle door further has a window and an associated window shaft, and wherein each actuation region is provided on a window shaft strip closing off the window shaft or as a window shaft strip closing off the window shaft.

12. The vehicle door according to claim 11, wherein the second direction is different from the first direction, preferably opposite thereto.

13. The vehicle door according to claim 11, further comprising:
a second actuation region which is spaced from the first actuation region and from the sensor region, wherein the portion or element or another portion or element of the measuring device undergoes a deformation in a fourth direction which is different from the second direction when the second actuation region is subjected to force in a third direction, and wherein the measuring device emits a switching signal of a second type due to this deformation.

14. The vehicle door according to claim 13, wherein the first and fourth directions are identical and/or the second and third directions are identical.

15. The vehicle door according to claim 11, wherein the measuring device comprises a strain gauge, an inductive sensor and/or a capacitive sensor.

16. The vehicle door according to claim 11, further comprising a base body, in particular made of metal or hard plastic, of which a handle portion provides the first actuation region and/or the second actuation region and a foot portion provides the sensor region.

17. The vehicle door according to claim 16, wherein the base body has means on the foot region for fastening the actuating device to an external object, in particular to a vehicle door.

18. The vehicle door according to claim 16, wherein the handle portion is C-shaped or L-shaped in cross section.

19. A motor vehicle having the vehicle door according to claim 11.

20. The motor vehicle according to claim 19, wherein each actuation region is formed flush with the window shaft strip on another vehicle door following the vehicle door.

21. The vehicle door according to claim 12, further comprising: a second actuation region which is spaced from the first actuation region and from the sensor region, wherein the portion or element or another portion or element of the measuring device undergoes a deformation in a fourth direction which is different from the second direction when the second actuation region is subjected to force in a third direction, and wherein the measuring device emits a switching signal of a second type due to this deformation.

22. The vehicle door according to claim 12, wherein the measuring device comprises a strain gauge, an inductive sensor and/or a capacitive sensor.

23. The vehicle door according to claim 13, wherein the measuring device comprises a strain gauge, an inductive sensor and/or a capacitive sensor.

24. The vehicle door according to claim 14, wherein the measuring device comprises a strain gauge, an inductive sensor and/or a capacitive sensor.

25. The vehicle door according to claim 12, further comprising a base body, in particular made of metal or hard plastic, of which a handle portion provides the first actuation region and/or the second actuation region and a foot portion provides the sensor region.

26. The vehicle door according to claim 13, further comprising a base body, in particular made of metal or hard plastic, of which a handle portion provides the first actuation region and/or the second actuation region and a foot portion provides the sensor region.

27. The vehicle door according to claim 14, further comprising a base body, in particular made of metal or hard plastic, of which a handle portion provides the first actuation region and/or the second actuation region and a foot portion provides the sensor region.

28. The vehicle door according to claim 15, further comprising a base body, in particular made of metal or hard plastic, of which a handle portion provides the first actuation region and/or the second actuation region and a foot portion provides the sensor region.

29. The vehicle door according to claim 17, wherein the handle portion is C−
